(19) United States
(12) Patent Application Publication
(10) Pub. No.: US 2003/0109989 A1
(43) Pub. Date: Jun. 12, 2003

(54) Geophone coupling

(76) Inventors: Claudio Bagaini, Milano (IT); Shuki Ronen, Crompton (IL); Everhard Muyzert, Cambridge (GB)

Correspondence Address: David S Figatner, WesternGeco, Intellectual Property Department, P O Box 2469, Houston, TX, 77252-2469, US

(21) Appl. No.: 10/181,219

(22) PCT Filed: Jan. 12, 2001
(86) PCT No.: PCT/GB01/00133

(30) Foreign Application Priority Data
Jan. 14, 2000 (GB) 0000900.1

(51) Int. Cl. G01V 1/28

(52) U.S. Cl. 702/14

(57) ABSTRACT

A method of analysing a seismic signal comprising two orthogonal horizontal components, the method comprising using two geophones to record data corresponding to each component, and generating a frequency dependent calibration operator to correct the data corresponding to one component using the shear wave data corresponding to the other component in order to compensate for different coupling between the geophone and each component of the signal.

The present invention relates to seismic geophone coupling, and in particular to geophone coupling in seismic surveys conducted at the sea floor.

There are a number of methods that can be used when conducting seismic surveys at the sea floor. Generally, a vessel at the surface activates a signal source immersed in water, which generates a pressure wave in the water. An array of seismic sensors, such as a Nessie™ 4C multiwave array, or one or more Ocean Bottom Cables/Seismometers (OBC/OBS) is provided on the seabed. The term 4C here indicates 4 component, because the sensors detect the reflected P-waves and the X, Y & Z components of the reflected shear waves. The OBC has a number of multicomponent receivers or receiver groups, consisting of geophones, which measure, among other components, the horizontal velocity of the sea floor in two directions, X (inline with the cable) and Y (crossline to the cable). The signal from the geophones is then usually recorded on a vessel at the surface.

The signal generated by the source initially propagates through the water as a longitudinal wave, known as a P-wave. This wave will propagate through theesea, and then through layers under the sea bed. After the firing of the source, the OBC will record the arrival of the “water break” or direct wave, followed by reflections from interfaces such as the water surface, the sea floor and layers under the sea floor. Depending on the angle of incidence, mode conversions can occur at each interface. Thus the energy of the wave may propagate through the material under the sea bed partly in the form of a longitudinal P-wave, and partly in the form of a transverse or PS-wave. The PS-wave is largely visible in the horizontal X and Y components measured.

It is known that such systems can suffer from poor sensor coupling in certain circumstances, and different geophone response and coupling can arise for different components. The Y-component coupling for a PS-wave of a Nessie™ 4C multiwave array deployed on a hard sea bed is known to be the least reliable component.

It is shown in Krohn, Chr., 1984, Geophone Ground Coupling, Geophysics 49, pp. 722-731, that poor coupling of geophones can be explained using a model for the geophone ground coupling. The geophone ground coupling is modelled as a damped oscillator.

U.S. Pat. No. 5,235,554 (Barr & Sanders) describes a method for correction of differences in impulse response between the Z-component geophone and a hydrophone using water breaks.

U.S. Pat. No. 5,724,306 (Barr) presents a correction method for the Z-component using hydrophone measurements and a model for geophone response. In an inversion procedure differences in transfer functions between the sensor and the model are minimized by adjusting the resonant frequency and damping parameters of the model.

U.S. Pat. No 6,021,090 (Gaiser, Barr and Paffenholz) presented a method for correction of the Y-component of OBC data using the Z-component. His method minimises the energy on the transverse-horizontal component of first breaks and early near-offset arrivals. The PS-waves are later arrivals on larger offset shots.

According to a first aspect the present invention provides a method of analysing a seismic signal comprising two orthogonal horizontal components recorded by a sensor package containing two horizontal geophones, the method comprising generating a frequency dependent calibration operator to correct data corresponding to one component using data corresponding to the other component in order to compensate for different coupling between the geophone and each component of the signal.

From here on in this specification a single sensor package or sensor group with one output is considered to design the calibration operator to be applied to compensate for inconsistent coupling at a location. Extension of the invention to a real survey including several sensor packages is straightforward because the operators are designed and applied in a receiver consistent manner.

Preferred features of the invention are set out in the accompanying dependent claims.

According to a second aspect, the invention provides a method of performing a seismic survey of earth formations beneath the seabed, comprising generating a signal, measuring the signal at the seabed using a geophone, and analysing the signal as described above.

Preferred embodiments of the invention provide a means of compensating for inconsistent Y-coupling without the need for any modelling of the behaviour of the geophone as a damped oscillator, and without the need for determining any correlation between the behaviour of the Z-component and the horizontal components.

Some preferred embodiments of the invention will now be described by way of example only and with reference to the accompanying drawings, in which:

FIG. 1 shows schematically the elements of a multicomponent seismic survey at the sea floor;

FIG. 2 shows the geometry of various signals arriving at an Ocean Bottom Cable (OBC);

FIG. 3 shows the output from a well coupled sensor and a poorly coupled sensor in response to a signal at 45° to the X-direction;

FIG. 4 shows the geometry of a signal arriving at a geophone at angle θ to the X-direction of an OBC;

FIG. 5 is a flow chart showing an algorithm for the correction of all the Y-components of a Common Receiver Gather (CRG) using the calibration operator designed on the fly.

FIG. 6 shows the X and Y components recorded at two neighbour receiver locations.

FIG. 7 shows the signals recorded by three geophones (two in the seabed plane and one vertical to it) and a hydrophone all four embedded in the cable at the same location.

FIG. 8 shows the Y component before and after calibration together with the X component at the same receiver location.

FIG. 9 shows the receiver consistent application of several calibration operators to a Common Azimuth Gather.

### A DETAILED DESCRIPTION OF THE FIGURES FOLLOW

FIG. 1 shows an arrangement used to perform a multicomponent seismiic survey acquired at the sea floor. On the sea bed 1 an Ocean Bottom Cable (OBC) 2 is deployed. The OBC 2 has a number of multi-component receivers or receiver groups 3 comprising geophones that each measure the horizontal velocity of the sea floor 1 in two directions, X and Y. The geophone signal is recorded on a vessel 4 at the surface. While the motion of the sea bed is recorded, another vessel 5 fires a source 6, for example an airgun array, in the water. Following the firing of the source 6, the OBC 2 will record the water break or direct wave, followed by signals generated by reflections from interfaces such as the water surface, the sea floor 1 and interfaces 7 between layers 8, 9 under the sea floor 1. Depending of the angle of incidence, at each interface mode conversions can occur. The incidence P-wave 10 is shown in FIG. 1 reflected from the sub sea floor interface 7 as a combination of a P-wave 11 and a S-wave 12 The S-wave 12 is detected by the geophones 2 mainly in the horizontal components.

The source 6 used in such surveys is usually an airgun array, which is a compressional source, but any other source of seismic energy can be used such as a shear-wave source (on or under the seabed), marine vibrator or earthquake. Although the source 6 is shown in FIG. 1 as being immersed in the water, the invention will work equally well for a source located at or under the sea floor.

FIG. 2 shows a range of possible shot geometries. A signal 13 directed along the x-axis of the OBC 2 is known as an inline shot, and a signal 14 parallel to the y-axis is known as a crossline shot. A shot 15 at 45° to the x-axis is also shown. Following such a shot, identical signals for the X and Y component would be expected for a well coupled geophone. This is true under the assumption of an isotropic one-dimensional layered earth.

If the geophone is not well coupled the signals for the X and Y-components may not be identical. In FIG. 3 the signals from a well coupled geophone and a poorly coupled geophone are compared. Trace 16 is the X-component of the signal recorded by a well coupled geophone. Trace 17 is the X-component of a signal recorded by a poorly coupled geophone. Trace 18 is the Y-component of the signal recorded by the well coupled geophone, and trace 19 is the Y-component of the signal recorded by the poorly coupled geophone. All of the traces show the signal varying with time.

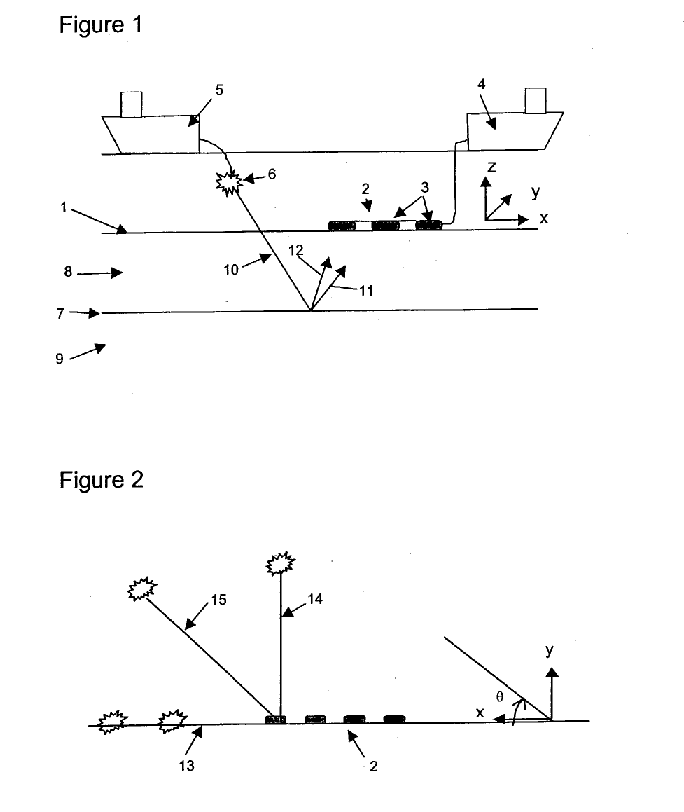

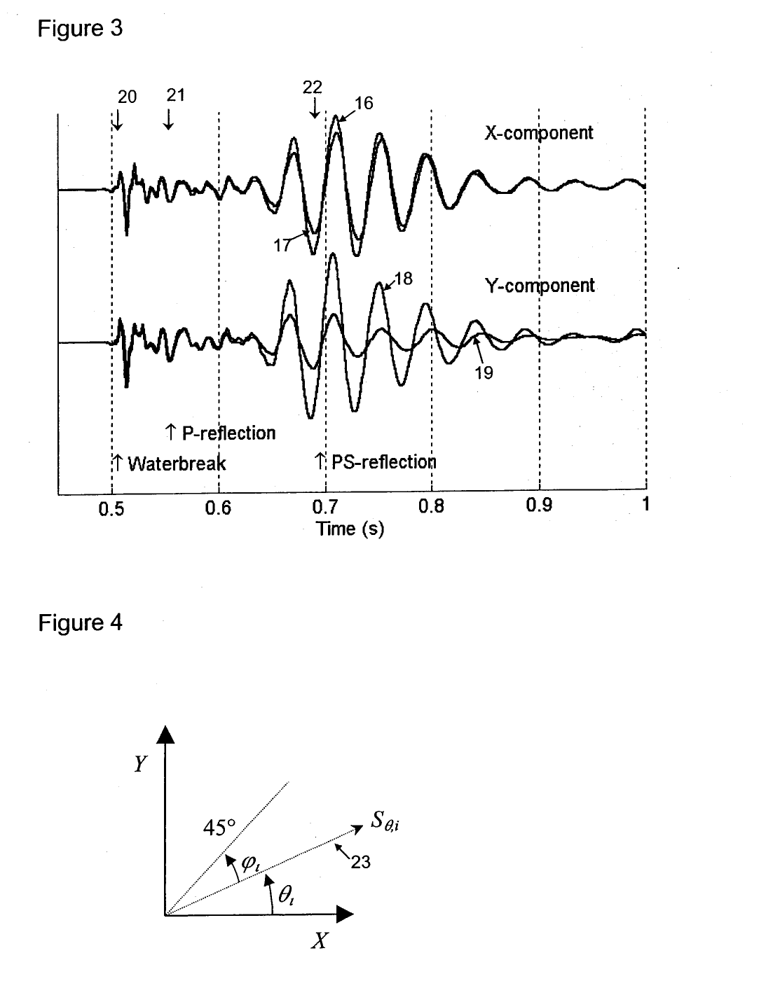

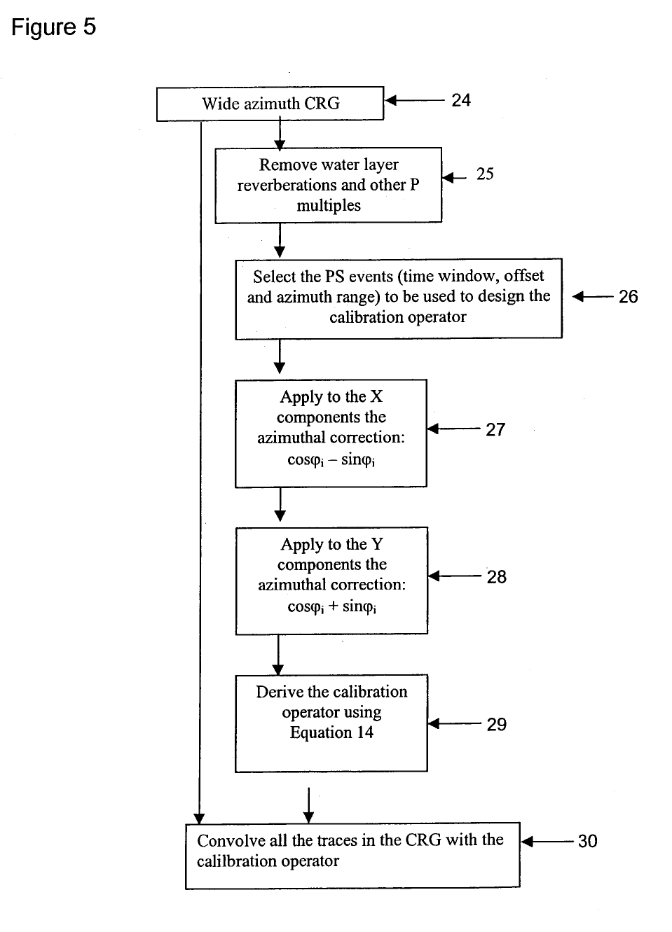

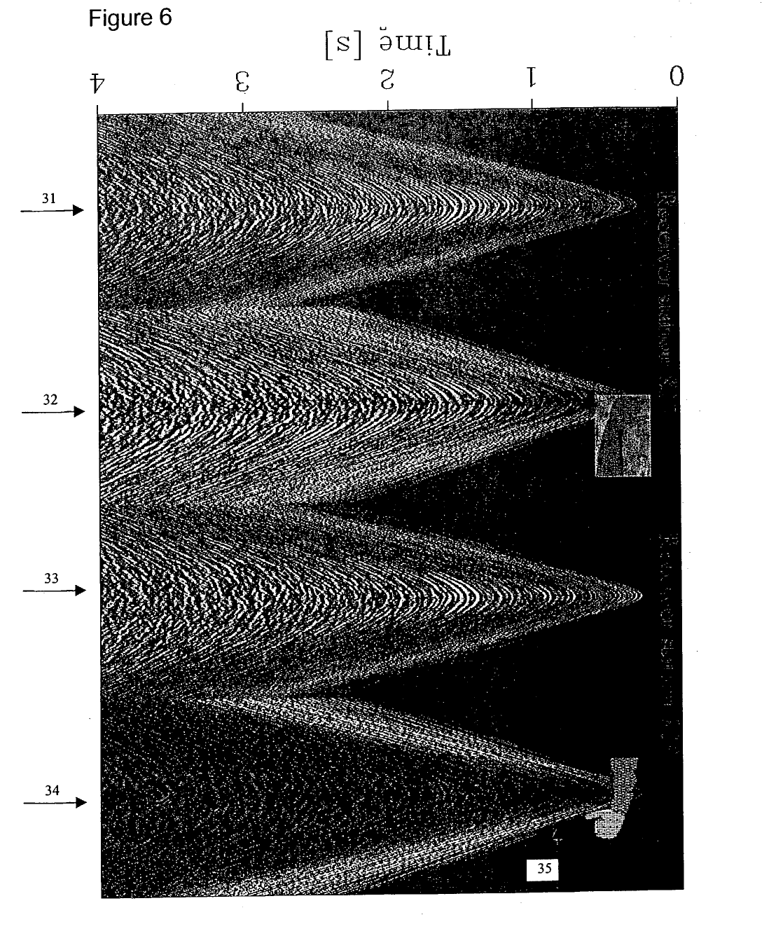

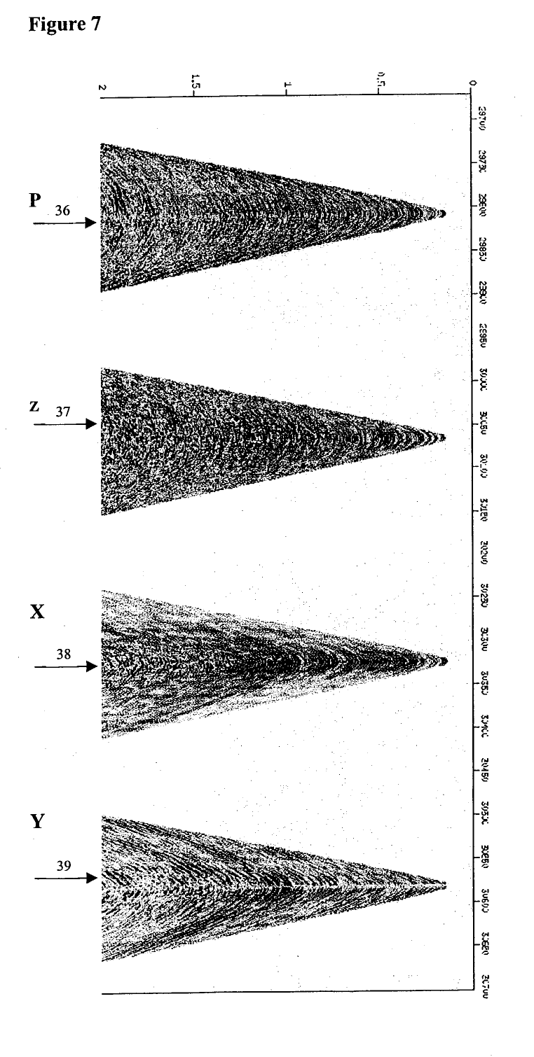

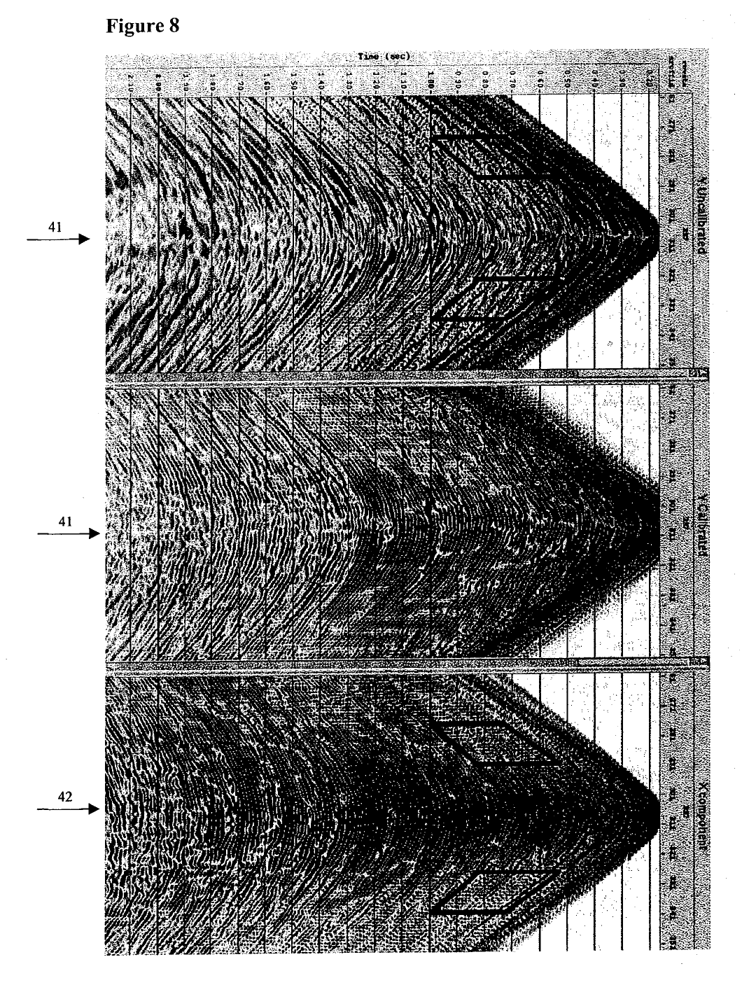

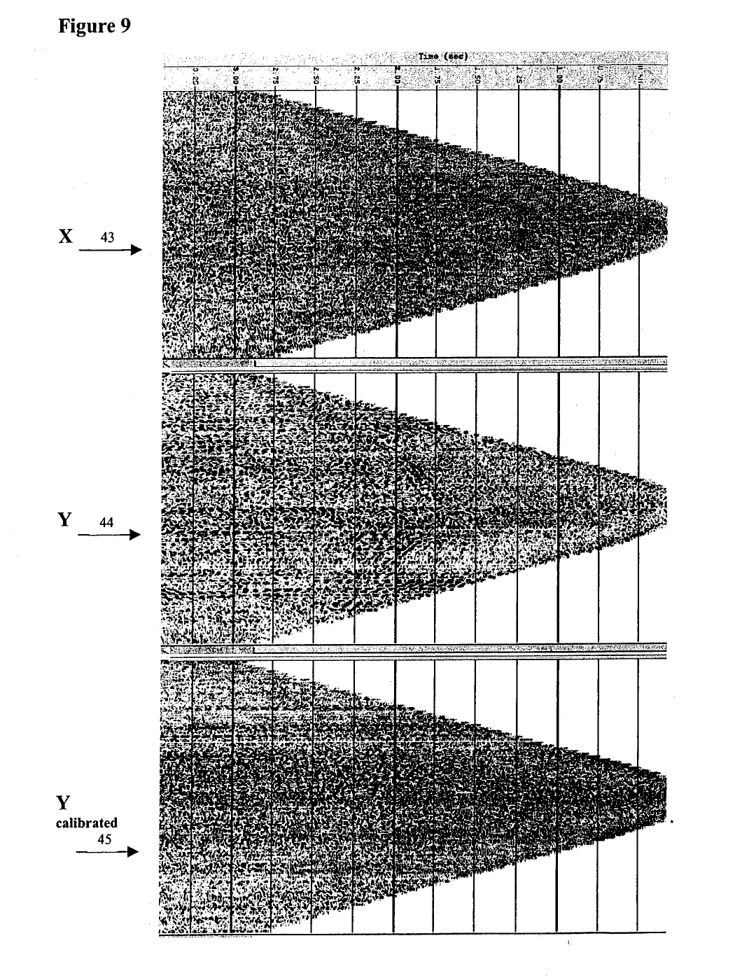

The “waterbreak” signal arrives first, after 0.5 seconds, and is shown at 20. This is the signal generated by the incoming P-wave directly from the source. Since this wave is propagated through the water it is well coupled on both geophones, which normally rest in the water on the sea bed. The P-reflection 11 (see FIG. 1) arrives next, and is recorded at 21. This signal is also well coupled on both geophones, as even the P-reflection 11 arriving from the sub sea floor interface 7 will transmit most of its energy into the water across the interface of the sea bed 1. The PS-reflections 12 (see FIG. 1) are shown generally at 22. Very little of the energy of the PS-reflections 12 can be transmitted into the water so the coupling of the geophones to the sea bed is now crucial.

The X-components 16, 17 of the PS-reflections 22 recorded by the two geophones are well in agreement. However, Y-component signals 18, 19 recorded by the two geophones are different. The signal 19 recorded by the poorly coupled geophone is weaker that that 18 recorded by the well coupled geophone and has phase differences. Water break 20 and P-reflection 21 signals are therefore not representative for this kind of coupling behaviour.

Consider a signal S_{θ,i} 23 arriving at a geophone under azimuth θ in the horizontal plane and recorded as the j^{th} component (i=x,y), as shown in FIG. 4. The geophone measures a signal proportional to the x and y component of the ground motion G_{θ,i}. The frequency response ƒ of the geophone is given by equation 1 where Cⱼ is the coupling transfer function.

G_{θ,j}(ƒ)=Cⱼ(ƒ)·S_{θ}(ƒ), j=x,y Equetion 1

Cⱼ (ƒ) can vary for each component due to differences in design and degree of coupling. No explicit dependence of Cⱼ (ƒ) on the angle of incidence has been expressed, in fact the incoming horizontal particle motion can always be decomposed in a component parallel to the cable (X) and in one orthogonal to it (Y).

In absence of substantial azimuthal anisotropy and out of plane scattering effects the X and Y signals at θ=45° should be identical. In other words, if the two are equally well coupled (i.e. Cₓ (ƒ)=C_{y} (ƒ), the following identity would be valid:

G_{45°,x}(ƒ)=G_{45°,y}(ƒ) Equation 2

It is assumed that if the geophone has non-identical coupling for x and y components, the signal recorded for the y-component is multiplied by a transfer function T(ƒ) in order to obtain the same signal for both x and y-components. It is moreover assumed that this transfer function is time invariant.

G_{45°,x}(ƒ)=T(ƒ)·G_{45°,y}(ƒ) Equation 3

In absence of noise the transfer function would simply be:

$$T ( f ) = \frac{{C}_{x} ( f )}{{C}_{y} ( f )} \qquad Equation 4$$

Equation 3 can be written as:

$$T ( f ) = \frac{{G}_{{45}^{0} , x} ( f )}{{G}_{{45}^{0} , y} ( f )} \qquad Equation 5$$

A rotation matrix R(φ) can be used to rotate in the xy-plane the sensor package, constituted of the two horizontal geophones, by an angle φ.

G_{θ+φ}(ƒ)=R(φ)·G_{θ}(ƒ) Equation 6

The rotation matrix, which is defined by:

$$R ( ϕ ) = [ \begin{matrix}cos ϕ & - sin ϕ \\ sin ϕ & cos ϕ\end{matrix} ] , \qquad Equation 7$$

can be applied to the X and Y component to simulate an ideal experiment with the two horizontal geophones rotated of φ degrees with respect to the actual shot-receiver line.

FIG. 4 shows the special case of a sensor package rotated of an angle of φ=45°−θ so that the azimuth of the rotated geophone and incoming signal is θ=45°:

G_{45°,x′}(ƒ)=cos φ·G_{θ,x}(ƒ)−sin φ·T(ƒ)·G_{θ,y}(ƒ)

G_{45°,y′}(ƒ)=cos φ·G_{θ,x}(ƒ)+cos φ·T(ƒ)·G_{θ,y}(ƒ) Equation 8

In Equation 8 the y-component geophone response has been corrected using the transfer function T(ƒ).

At θ=45°, the rotated geophone responses should therefore be equal:

G_{45°,x′}(ƒ)=G_{45°,y′}(ƒ) Equation 9

For a Common Receiver Gather (CRG) with wide azimuth coverage, several traces are available and the above formulation to obtain the transfer function T(f) of the calibration filter can be extended to all these traces, N_{S}. The over-determined system of linear equations can be written for each frequency as:

G_{θ}_{ᵢ}_{,y}(ƒ)r(φᵢ)T(ƒ)=G_{θ}_{ᵢ}_{,x}(ƒ),i=1,2, . . . N_{S} Equation 10

where

$$r ( {ϕ}_{i} ) = \frac{cos {ϕ}_{i} + sin {ϕ}_{i}}{cos {ϕ}_{i} - sin {ϕ}_{i}} = \frac{n ( {ϕ}_{i} )}{d ( {ϕ}_{i} )} . \qquad Equation 11$$

Equation 11 also defines the Y and X azimuthal correction terms, which are respectively d(φᵢ) and n(φᵢ). In order to have the system of equations 10 defined when d(φᵢ) vanishes, the system can be rewritten as:

G_{θ}_{ᵢ}_{,y}(ƒ)n(φᵢ)T(ƒ)=G_{θ}_{ᵢ}_{,x}(ƒ)d(φᵢ), i=1,2, . . . N_{S}, Equation 12

whose least squares solution is:

$$T ( f ) = \frac{{\sum }_{i = 1}^{Ns} {G}_{{θ}_{i , x}} ( f ) {{G}_{θi , y}^{*}}^{} ( f ) n ( {ϕ}_{i} ) d ( {ϕ}_{i} )}{{\sum }_{i = 1}^{Ns} {G}_{{θ}_{i , y}} ( f ) {G}_{θi , y}^{*} ( f ) {n}^{2} ( {ϕ}_{i} )} . \qquad Equation 13$$

For sake of notations the above formulation to derive the calibration operator has been carried in the Fourier domain, however equation 13 expresses that the calibration operator is the matching filter between the function G_{θi,y}(ƒ) n(φᵢ) and the function G_{θi,x}(ƒ) d(φᵢ). Using the property of the Z transform Equation 13 can be rewritten in the original time domain:

$$T ( Z ) = \frac{{\sum }_{i = 1}^{Ns} {G}_{{θ}_{i , x}} ( Z ) {G}_{{θ}_{i , y}} ( 1 / Z ) n ( {ϕ}_{i} ) d ( {ϕ}_{i} )}{{\sum }_{i = 1}^{Ns} {G}_{{θ}_{i , y}} ( Z ) {G}_{{θ}_{1 , y}} ( 1 / Z ) {n}^{2} ( {ϕ}_{i} )} . \qquad Equation 14$$

The numerator of equation 14 is the sum of the crosscorrelations of the X and Y components azimuthally corrected using respectively with the factors d(φᵢ) and n(φᵢ). The denominator is the sum of the azimuthally corrected autocorrelations of the Y components. For efficiency reasons the derivation of the calibration operator is carried in the time domain.

FIG. 5 shows the data flow for correcting the Y components using the algorithm described before. It is assumed that the orientation of the horizontal geophones has been assessed using the direct arrivals or positioning information, which are P waves, and are therefore less sensitive to inconsistent coupling as shown in FIG. 6. From a CRG with wide azimuth coverage 24 the water layer reverberations and the other P multiples are removed during a pre-processing phase. Early converted wave (PS) events are selected in the short to medium offset range (typically 600 to 1000 m). The water break 20 and other early arriving signals 21 are not selected. Later arriving Scholte waves and mud roll are also removed. The windowed signal 26 now contains mainly PS-reflection energy 22.

Next the azimuthal correction terms 27 and 28 are applied to the X and Y components. Finally the calibration operator, T(f), is derived using Equation 14. The corrected Y-component signal for each trace of the CRG is obtained by convolving the calibration operator with the original CRG Y traces.

FIG. 6 shows the X and Y components recorded at two neighbour locations, which were only 25 meters apart, labelled in the figure as Receiver station 827 and 829. 31 and 32 are respectively the X and Y components at receiver location 827, 33 and 34 are respectively the X and Y components at the receiver location 829. The same plotting scale has been used for all these traces. 31 and 33 have comparable quality, but the 34 is of poorer quality than 32, the reflected signals are in fact very weak. Despite the general poorer quality of 34, the first arrivals 35, both direct and refracted, which are essentially compressional waves, have been properly recorded at 34 as well. Coupling for crossline geophones is typically more critical because of the smaller extent of the sensor package in that direction. The extreme case shown in this example highlights the need to use converted wave events to calibrate horizontal geophones, which is one of the claims of this invention.

The effectiveness of the described calibration strategy depends on the validity of the assumption that inconsistent Y coupling can be compensated using only the X component. FIG. 7 qualitatively shows the validity of this assumption for the seabed data recorded with the currently available generation of seabed acquisition systems. FIG. 7 shows the data recorded by two horizontal (38 and 39) and one vertical geophone (37) embedded in a cable together with a hydrophone (36). All these components are assembled in the same sensor package. Because of the very low P and particularly S velocities of the shallow layers the incident angle, for offsets and target depths typical of exploration geophysics, is approximately perpendicular to the seabed plane. The moveout velocities of the reflections recorded by the two horizontal geophones should therefore be substantially smaller than those recorded by the vertical geophone if nocross-talk between horizontal and vertical geophones occur. FIG. 7 shows that for a typical receiver location this situation is verified. In the case of the cross-talk phenomenon is not negligible a hardware solution consists in assembling the horizontal geophones in a package separated from the vertical one.

FIG. 8 shows the horizontal components of a common receiver gather before (40) and after (41) calibration of the Y component. The data used to design the operators are black framed. 40 is the original Y. The Y mid trace has very little energy because has been obtained with a shot at the crosspoint between receiver and shot line, that is shooting on the inline. The calibration of this common receiver gather affects the amplitudes and phases of the Y gather. The Y amplitudes are generally scaled up and more comparable with the X ones (42). The X signal, as expected, substantially decreases at large offsets because of shooting on the crossline.

FIG. 9 shows the result of the application of the algorithm subject of this invention to an entire seabed seismic survey, only the traces whose azimuth is approximately 45 degrees are shown. Assuming that out of plane scattering effects and azimuthal anisotropy have negligible effects the X and Y common azimuth gathers should be comparable. This is not the case with the original data, left panel 43 for the X and middle panel 44 for the Y. After calibration the Y traces 45 shown in the right panel have a frequency content comparable with the X and the resonant phenomena have been attenuated.

1. A method of analysing a seismic signal comprising two orthogonal horizontal components recorded by a geophone, the method comprising generating a correction factor to correct data corresponding to one component using data corresponding to the other component in order to compensate for different coupling between the geophone and each component of the signal.

2. A method as claimed in claim 1, wherein more than one seismic signal is measured, the method comprising using the same correction factor to correct the data corresponding to said one component of each signal.

3. A method as claimed in claim 1 or 2, wherein the correction factor is determined using the fact that the data corresponding to the two components would be expected to be equal when the direction of each component is 45° to the direction of propagation of the signal.

4. A method as claimed in any preceding claim, wherein the signal comprises a transverse PS-wave component, and wherein the correction factor is determined from data corresponding to the PS-wave component of the signal.

5. A method as claimed in any preceding claim, wherein the direction of one horizontal component of the signal is defined as the x-direction, this component being the x-component, and the direction of the other horizontal component of the signal is defined as the y-direction, this component being the y-component, the signal arriving at a horizontal angle of θ to the x-component, and wherein the data corresponding to the y-component is corrected using the data corresponding to the x-component.

6. A method as claimed in any preceding claim, wherein the signal comprises a waterbreak and the direction of propagation of the signal is determined using polarisation analysis of data corresponding to the waterbreak.

7. A method as claimed in any preceding claim, wherein the horizontal angle between the direction of travel of the signal and one of the horizontal components of the signal is θ, and wherein a Fourier transform is performed on the data corresponding to each component of the signal, to generate a function G_{θ,x}(ƒ) from the data corresponding to the x-component and a function G_{θ,y}(ƒ) from the data corresponding to the y-component, and wherein a transfer function T(ƒ) is generated wherein T(ƒ)=tan θ·G_{θ,x}(ƒ)/G_{θ,y}(ƒ), the transfer function T(ƒ) being the correction factor.

8. A method as claimed in 7, wherein more than one signal arrives at the geophone, at one or more angles θ, and a Fourier transform is performed on the data corresponding to each component of each signal as described in claim 8, but wherein the transfer function T(ƒ) is generated for the first signal only and used to correct the data corresponding to the y-components of all of the signals.

9. A method as claimed in any of claims 1 to 6, wherein more than one signal arrives at the geophone, at one or more angles θ to the x-direction, and wherein a single transfer function is generated by which the Fourier transform of the data corresponding to the y-component for each signal can be multiplied in order to correct that data.

10. A method as claimed in claim 9, wherein the transfer function is generated from the data from a single signal.

11. A method as claimed in claim 9, wherein the transfer function is generated from the sum of data from all of the signals, the data having first been rotated through an angle of φ=45°−θ.

12. A method as claimed in claim 9, wherein the transfer function is generated from data from all of the signals using singular value decomposition.

13. A method as claimed in any preceding claim, wherein the geophone is part of an Ocean Bottom Cable (OBC).

14. A method as claimed in claim 13, wherein the x-direction is defined as being in the direction of the OBC.

15. A method as claimed in any preceding claim, wherein said geophone is a sensor package containing two horizontal geophones.

16. A method as claimed in any preceding claim, wherein said correction factor is a frequency dependent calibration operator.

17. A method of performing a seismic survey of earth formations beneath the seabed, comprising generating a signal, measuring the signal at the seabed using a geophone, and analysing the signal using the method of any preceding claim.

18. A method as claimed in claim 17, wherein the signal is generated by an airgun array.

19. A method of measuring seismic data as herein described with reference to the accompanying drawings.

20. A method of performing a seismic survey as herein described with reference to the accompanying drawings.
